(19) United States
(12) Patent Application Publication
(10) Pub. No.: US 2012/0107601 A1
(43) Pub. Date: May 3, 2012

(54) SYSTEMS AND METHODS OF TEMPLATING USING PARTICLES SUCH AS COLLOIDAL PARTICLES

(75) Inventors: David A. Weitz, Bolton, MA (US); Roland S. Weitz, Bolton, MA (US); Roland S. Koltzenburg, Dannstadt (DE); Jens B. Rieger, Ludwigshafen (DE); Andre R. Studart, Zurich (CH); James N. Wilking, Somerville, MA (US)

(73) Assignees: BASF SE, Ludwigshafen (DE); President and Fellows of Harvard College, Cambridge, MA (US)

(21) Appl. No.: 13/203,257

(22) PCT Filed: Mar. 12, 2010
(86) PCT No.: PCT/US2010/000748

§ 371 Date: Jan. 4, 2012

Related U.S. Application Data
(60) Provisional application No. 61/160,040, filed on Mar. 13, 2009.

(51) Int. Cl. B32B 3/26; B29C 67/20

(52) U.S. Cl. 428/305.5; 264/49

(57) ABSTRACT

The present invention generally relates to systems and methods for using particle templating, e.g., to produce composites, discrete particles, or the like. In some embodiments, the present invention generally relates to the production of particles using the interstitial spaces between templating elements in a template structure. For example, a plurality of templating elements, which can include colloidal particles, may be arranged to form a template structure. The interstices of the templating elements can provide regions in which a fluid may be introduced. The fluid may be hardened (e.g., solidified) in some cases, e.g., to form a composite comprising the templating elements and the interstitial segments. In certain embodiments, the template structure may then be broken down to release the hardened fluid, e.g., as a plurality of discrete particles.

### RELATED APPLICATIONS

This application claims the benefit of U.S. Provisional Patent Application Ser. No. 61/160,040, filed Mar. 13, 2009, entitled “Systems and Methods of Templating Using Particles such as Colloidal Particles,” incorporated herein by reference.

### FIELD OF INVENTION

The present invention generally relates to systems and methods for using particle templating, e.g., to produce composites, discrete particles, network-like structures, foam-like structures, or the like. In some embodiments, the present invention generally relates to the production of structured morphologies of organic matter, in particular network-like structures and/or particles of organic matter using the interstitial spaces of a template structure. In certain embodiments, the particles include pharmaceutically active ingredients.

### BACKGROUND

A colloidal system is a type of mixture where one substance is dispersed throughout another. The dispersed substance is typically suspended in the mixture (instead of being dissolved, e.g., as in a solution). Thus, a colloidal system typically has at least two separate phases: a dispersed phase (or internal phase) and a continuous phase (or dispersion medium). A colloidal system may include solid, liquid, and/or gaseous components for each of the phases. For example, a colloidal system may comprise solid or gas particles surrounded by a liquid continuous phase, or solid particles surrounded by a solid continuous phase. An example of a colloidal system of solid particles surrounded by a liquid continuous phase is a dispersion (or sol), such as blood or certain types of paint.

### SUMMARY OF THE INVENTION

The present invention relates generally to systems and methods for using particle templating, e.g., to produce composites, discrete particles, network-like structures, foam-like structures, or the like. The subject matter of the present invention involves, in some cases, interrelated products, alternative solutions to a particular problem, and/or a plurality of different uses of one or more systems and/or articles.

One aspect of the present invention is directed to the use of template structures formed from a plurality of templating elements, which may define one or more interstitial spaces between the templating elements. In some cases, particles of substantially uniform size and/or shape may be formed using techniques such as those discussed herein. As discussed below, the ability to tailor the size and shape of such particles may have applications in various fields including, for example, pharmaceutical, agrochemical, drug delivery, cosmetics, feed and food, and optics, among others.

In some embodiments, a method is described. In some cases, the method comprises providing a template structure comprising a plurality of templating elements defining one or more interconnecting interstitial spaces, wherein at least about 80% of the points contained within the one or more interstitial spaces are located no more than about 1000 nm from a templating element. In some embodiments, the volume fraction of the templating elements in the template structure is at least about 0.5. The method may further comprise introducing a fluid into at least a portion of the interstitial spaces, and hardening the fluid to form a composite comprising the templating elements and interstitial segments of hardened fluid.

The method comprises, in some instances, providing a template structure comprising a plurality of templating elements defining one or more interconnecting interstitial spaces, wherein at least about 80% of the interstitial spaces are defined by at least four control lines, each control line containing the shortest imaginary line extending between two proximate templating elements, the center points of the control lines defining one or more polyhedral bodies, each of the polyhedral bodies having a volume of no more than about (750 nm)³. In some embodiments, the volume fraction of the templating elements in the template structure is at least about 0.5. The method may further comprise introducing a fluid into at least a portion of the interstitial spaces, and hardening the fluid to form a composite comprising the templating elements and interstitial segments of hardened fluid.

In some cases, the method comprises providing a template structure comprising a plurality of templating elements defining one or more interconnecting interstitial spaces, wherein at least about 80% of the interstitial spaces are defined by at least four control lines, each control line containing the shortest imaginary line extending between two proximate templating elements, the center points of the control lines defining one or more polyhedral bodies, each of the polyhedral bodies having a volume of no more than about 50% of the geometric average of the maximum cross-sectional dimensions of the templating elements raised to the third power. The method may further comprise introducing a fluid into at least a portion of the interstitial space, and hardening the fluid to form a composite comprising the templating elements and interstitial segments of hardened fluid.

The method comprises, in some embodiments, providing a network of templating elements, at least about 70% of the templating elements are in close proximity to at least one other templating element such that the shortest distance between the two surfaces of the two templating elements is less than or equal to about 20% of the geometric average of the maximum cross-sectional dimensions of the two templating elements. In some embodiments, the volume fraction of the templating elements in the template structure is at least about 0.5. The method may further comprise introducing a fluid into at least a portion of the network of templating elements such that the fluid occupies at least a portion of the interstices between the templating elements such that the templating elements are not all covered completely with the fluid. The method may also comprise hardening the fluid to form a composite comprising the templating elements and interstitial segments of hardened fluid such that at least about 80% of the points contained within the hardened fluid are no more than about 1000 nm from a templating element.

In some embodiments, a method of making particles is described. In some embodiments, the method comprises providing a template structure comprising a network of templating elements defining one or more interconnecting interstitial spaces, wherein at least about 80% of the points contained within the interstitial spaces are no more than about 1000 nm from a templating element. In some embodiments, the volume fraction of the templating elements in the template structure is at least about 0.5. In addition, the method may comprise introducing at least one fluid into at least a portion of the interstitial spaces, hardening the fluid to form a composite comprising templating elements and interstitial segments of hardened fluid, and at least in part dissociating the composite to form particles.

In some embodiments, a method of making active particles is described. The method may comprise, in some instances, providing a template structure comprising a network of templating elements defining one or more interconnecting interstitial spaces, wherein at least about 80% of the interstitial spaces are defined by at least four control lines, each control line containing the shortest imaginary line extending between two templating elements, the center points of the control lines defining one or more polyhedral bodies, each of the polyhedral bodies having a volume of no more than about (750 nm)³. In some embodiments, the volume fraction of the templating elements in the template structure is at least about 0.5. The method may also comprise introducing at least one fluid into at least a portion of the interstitial spaces, hardening the fluid to form a composite comprising templating elements and interstitial segments of hardened fluid, and at least in part dissociating the composite to form chemically and/or biologically active particles.

In another aspect, an article is provided. In some embodiments, the article can comprise a template structure comprising a plurality of templating elements defining one or more interconnecting interstitial spaces, and a hardened fluid within at least a portion of the interstitial spaces. In some instances, the volume fraction of the templating elements in the template structure is at least about 0.5. In some cases, the hardened fluid is capable of substantially completely dissolving within an excess of aqueous solvent within about 10 minutes.

The article can comprise, in some embodiments, a template structure comprising a plurality of templating elements defining one or more interconnecting interstitial spaces, and a hardened fluid within at least a portion of the interstitial spaces, wherein the hardened fluid exhibits a dissolution rate in an excess of aqueous solvent under ambient conditions that is at least about 2 times greater than a control dissolution rate, in the excess of aqueous solvent, of a sample of the hardened fluid having the same volume but absent the templating elements.

In some instances, the article can comprise a template structure comprising a plurality of templating elements defining one or more interconnecting interstitial spaces, and a hardened fluid within at least a portion of the interstitial spaces, wherein the volume of the article is reducible to form a first sub-composite with a first volume and a second sub-composite with a second volume that is at least 10³ times smaller than the first volume. In some embodiments, the hardened fluid within the first sub-composite exhibits a first non-zero dissolution time in an excess of aqueous solvent and the hardened fluid within the second sub-composite exhibits a second non-zero dissolution time in the excess of aqueous solvent. In some cases, the first dissolution time can be within about 25% of the second dissolution time, relative to the smaller of the first and second dissolution times.

The article can comprise, in some embodiments, a template structure comprising a plurality of substantially spherical templating elements having a maximum cross-sectional dimension of less than about 1 mm, defining one or more interconnecting interstitial spaces, and a hardened fluid within at least a portion of the interstitial spaces, wherein the volume fraction of the templating elements in the template structure is at least about 0.5.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 includes a schematic illustration of a template structure, according to one set of embodiments;

FIG. 2 includes a schematic illustration, according to one set of embodiments, of templating elements;

FIGS. 3A-3C illustrate, according to some embodiments, the disassociation of hardened fluid particles;

FIG. 4 includes a schematic illustration of a template structure, according to one set of embodiments;

FIG. 5 includes, according to some embodiments, a schematic illustration of a template structure;

FIG. 6 includes a schematic illustration of a templating process, according to one set of embodiments;

FIG. 7 includes photographs and micrographs of slip casting procedures, according to some embodiments;

FIG. 8 includes, according to some embodiments, photographs illustrating the introduction of fluid into a template structure;

FIGS. 9A-9C include micrographs of template structures, according to one set of embodiments;

FIGS. 10A-10D include, according to one set of embodiments, micrographs of template structures;

FIGS. 11A-11B include micrographs of a template structure (a) before and (b) after adding cholesterol, according to one set of embodiments;

FIGS. 12A-12C include template structures according to some embodiments;

FIGS. 13A-13B include, according to one set of embodiments, micrographs of template structures into which fluid has been introduced;

FIGS. 14A-14B include micrographs of a network of hardened fluid, according to one set of embodiments;

FIG. 15 includes an exemplary plot of absorbance as a function of time;

FIG. 16 includes a series of confocal microscopy images depicting the breakup of a composite, according to one set of embodiments; and

FIG. 17 includes an exemplary plot of absorbance as a function of time.

### DETAILED DESCRIPTION

The present invention generally relates to systems and methods for using particle templating, e.g., to produce composites, discrete particles, network-like structures, foam-like structures, or the like. In some embodiments, the present invention generally relates to the production of structured morphologies or organic matter, in particular network-like structures and/or particles of organic matter, using the interstitial spaces between templating elements in a template structure. For example, a plurality of templating elements, which can include colloidal particles, may be arranged to form a template structure. The interstitial spaces of the templating elements can provide regions in which a fluid may be introduced. The interstitial fluid may be hardened (e.g., solidified) in some cases, e.g., to form a composite comprising the templating elements and interstitial segments of hardened fluid. In certain embodiments, the template structure may then be broken down, and the hardened interstitial fluid may be dissociated, e.g., to form a plurality of discrete, hardened fluid particles.

As used herein, the term “hardened” is used to refer to the process of substantially increasing the viscosity of a material, and is not necessarily limited to solidifying a material (although in one embodiment, a material is hardened by converting it into a solid). For example, a material may be hardened by gelling a liquid phase, or a material may be hardened using polymerization (e.g., IR- or UV-induced polymerization). In some embodiments, a material being hardened may go through a phase change (e.g., reducing the temperature of a material below its freezing point or below its glass transition temperature). A material may also be hardened by removing a solvent from a solution, for example, by evaporation of a solvent phase, thereby leaving behind a solid phase material. In some embodiments, a material may be hardened by removing a melting point depressing agent (e.g., removing a salt or other species from a water solvent, or, for example, by removing compounds such as urea or choline chloride, e.g. by extraction, etc.).

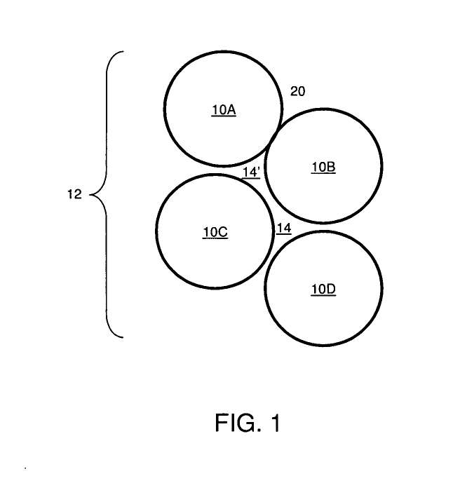

As a non-limiting example of such a template structure, referring now to FIG. 1, this figure includes a schematic illustration of a template structure 12. In FIG. 1, a plurality of spherical templating elements 10 are arranged to form template structure 12. Spherical templating elements are used in FIG. 1 for simplicity; in other embodiments, non-spherical templating elements may also be used, separately or in combination with spherical template structures. As discussed in detail below, interstitial spaces are generally defined as the spaces or regions between the templating elements, indicated by 14 in FIG. 1. These interstitial spaces can be used, for example, to provide regions in which fluid may be introduced. The templating elements may be arranged within the template structure such that at least some of them are in physical contact (e.g., templating elements 10A and 10B). In particular, not all of the templating elements necessarily are in physical contact with each other (e.g., templating elements 10C and 10D).

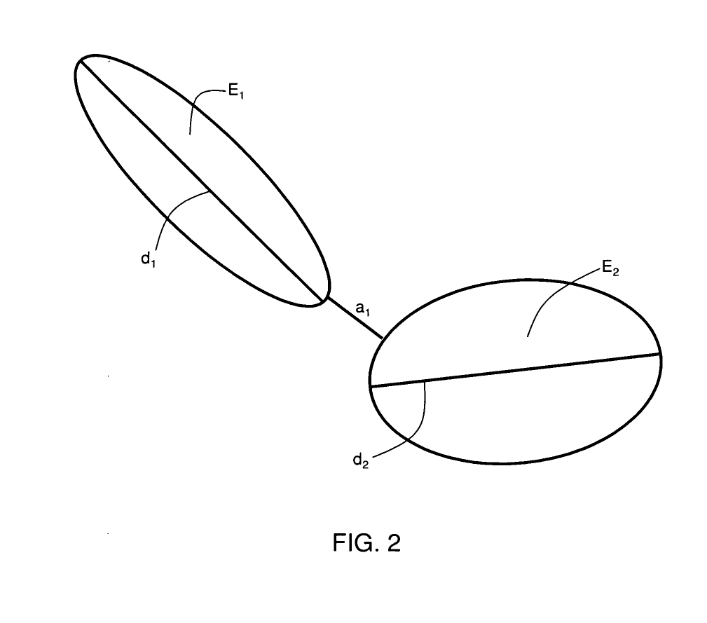

In some embodiments, the template structure is formed by arranging the templating elements such that the majority of the templating elements (e.g., at least about 70%, at least about 80%, at least about 90%, at least about 95%, or more) either touch at least one other templating elements, or are in close proximity to at least one other templating element. As used herein, two elements are “in close proximity” if the shortest distance between the two surfaces of the two elements is less than or equal to about 20% of the geometric average of the maximum cross-sectional dimensions of the two elements. The geometric average of a series of n numbers is given its normal meaning in the art, and is calculated as the nth root of the product of the series of n numbers. As used herein, the “maximum cross-sectional dimension” refers to the largest distance between two opposed boundaries of an individual structure that may be measured. For example, in FIG. 2, the maximum cross sectional dimension of ellipsoid E₁ is d₁, while the maximum cross-sectional dimension of ellipsoid E₂ is d₂. In addition, the shortest distance between the two surfaces of ellipsoids E₁ and E₂ is a₁ in this figure. Ellipsoids E₁ and E₂ are said to be in close proximity if is less than or equal to about 20% of the geometric average of d₁ and d₂ (i.e., the square root of d₁ times d₂). In some embodiments, at least about 80%, at least about 90%, or at least about 95%, at least about 99%, or substantially all of the templating elements are proximate to at least one other templating element such that the distance between the two templating elements is less than or equal to about 10%, about 5%, or about 2% of the geometric average of the maximum cross-sectional dimensions of the two templating elements.

The templating elements may be, in some cases, so closely packed that relatively high densities of templating elements are achieved. In some embodiments, the volume fraction of the templating elements (i.e., packing density) in a template structure, a suspension formed therefrom, and/or a composite formed therefrom is at least about 0.4, at least about 0.5, at least about 0.6, at least about 0.65, at least about 0.7, at least about 0.75, at least about 0.8, at least about 0.85, at least about 0.9, or at least about 0.95. One of ordinary skill in the art would be capable of calculating the volume fraction of templating elements by, for example, measuring the volume of the template structure, suspension, or composite, subsequently eliminating any material formed in the interstices, and measuring the volume of the templating elements. The volume of the templating elements can be measured, for example, by adding the templating elements to a fluid and measuring the volume of displaced fluid.

In some embodiments, the mass ratio of templating elements to fluid in a suspension and/or the mass ratio of templating elements to hardened fluid within a composite may be relatively high. For example, in some cases, the ratio of the mass of the templating elements to the mass of the fluid within a suspension can be at least about 1.5:1, at least about 2:1, at least about 3:1, at least about 4:1, or at least about 5:1. In some embodiments, the ratio of the mass of the templating elements to the mass of the hardened fluid within a composite can be at least about 1.5:1, at least about 2:1, at least about 3:1, at least about 4:1, or at least about 5:1.

In some cases, one or more methods can be employed to increase the relative volume and/or mass of templating elements within a suspension and/or composite, relative to the as-formed suspension and/or composite. Any suitable method can be used. For example, in some cases, pressure can be applied to the suspension and/or composite, thereby decreasing the distances between the templating elements. Pressure can be applied, for example, via centrifugation, via a press, or using any other suitable method. In some embodiments, the temperature of the composite can be increased to enhance the degree to which the templating elements can be compressed. A rise in temperature can lead to a decrease in the viscosity of the fluid between the templating elements, in some cases, allowing the templating elements to be packed closer together as they displace interstitial fluid, either under gravitational forces or with the application of pressure. In some embodiments, the relative volume and/or mass of the templating elements within a suspension and/or composite can be increased by removing fluid (e.g., liquid) from the system. Removal of fluid can be accomplished, for example, via evaporation, filtration, and/or reaction. In some cases, fluid removal can be performed after the application of pressure and/or a rise in temperature. For example, the application of pressure and/or a rise in temperature can result in the formation of a fluid rich sub-volume, which can be removed from the system to produce a templating element-rich suspension and/or composite.

In some embodiments, the composite may be the desired product of the process. For example, a fluid may be hardened in the interstices defined by the templating elements to form a pharmaceutical composite for administration to a subject.

In other embodiments, however, the composite may be processed such that the templating elements are removed from the structure. Methods for removing the templating elements from the composite include, for example, evaporation, dissolution, and/or reaction to form volatile or soluble components, among other methods, which are described in more detail later, or through a combination of these or other methods.

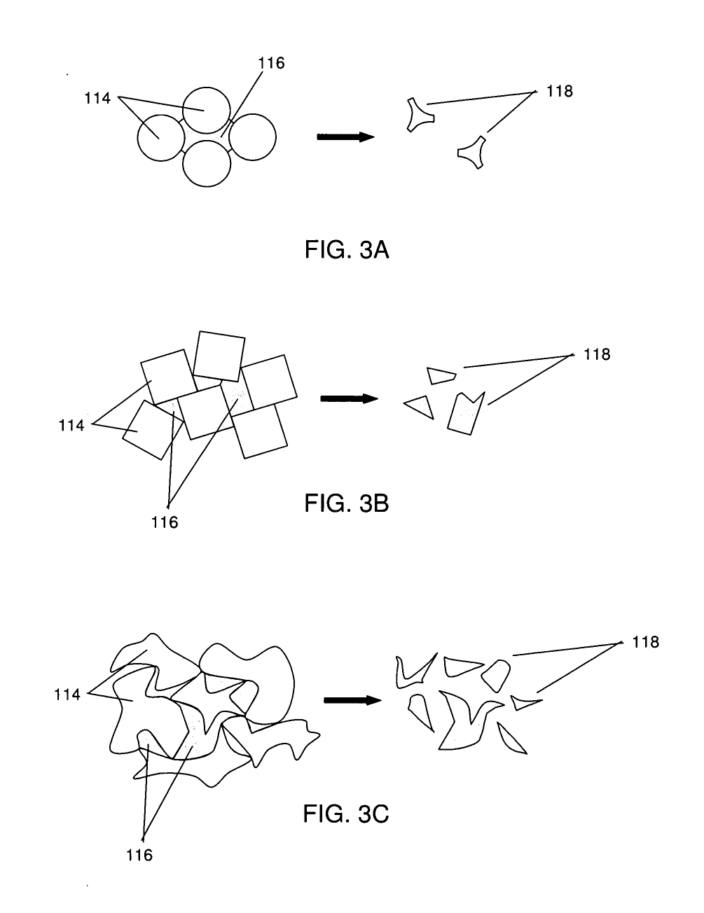

In addition, in some embodiments, the hardened interstitial fluid is dissociated to form a plurality of hardened fluid particles. The disassociation of hardened fluid particles can be achieved, for example, through grinding, decomposition of part of the hardened fluid, or via compaction, among other methods, as described in detail below, or through a combination of these or other methods. In some embodiments, the templating elements may be removed from the structure and the hardened interstitial fluid particles may be dissociated in a single step. For example, in one set of embodiments, a composite is crushed or ground, leaving templating elements separated from dissociated hardened fluid particles. FIGS. 3A-3C include schematic illustrations of the disassociation of hardened fluid particles 118 from composites of hardened interstitial fluid 116 and templating elements 114.

As discussed above, a plurality of templating elements may be used to create a template structure, according to some aspects of the invention. In some cases, the template structure is defined by the spatial arrangement of the templating elements. For example, some or all of the templating elements may be in physical contact or in close proximity with at least one other templating element, and the aggregation of these templating elements may form the template structure and define the interstitial spaces.

The templating elements may each independently have any suitable shape, regular or irregular, including, but not limited to, spheres, cubes, pyramids, etc. The templating elements may also each be formed of any suitable size. For example, the templating elements may have an average maximum cross-sectional dimension of less than about 1 mm, less than about 300 microns, less than about 100 microns, less than about 30 microns, less than about 10 microns, less than about 1 micron, less than about 500 nm, less than about 250 nm, less than about 100 nm, less than about 75 nm, less than about 50 nm, less than about 25 nm, less than about 10 nm, or, in some cases, less than about 5 nm. In some cases, the templating elements may comprise rods or platelets with varying aspect ratios (e.g., aspect ratios of at least about 2:1, at least about 5:1, at least about 10:1, at least about 20:1, or greater).

In some embodiments, the templating elements may be substantially the same shape and/or size (“monodisperse”). For example, the templating elements may have a distribution of dimensions such that no more than about 10% of the templating elements have a maximum cross-sectional dimension that varies by more than about 10% of the average maximum cross-sectional dimension of the templating elements, and in some cases, such that no more than about 8%, about 5%, about 3%, about 1%, about 0.3%, about 0.1%, about 0.03%, or about 0.01% have a maximum cross-sectional dimension that varies by more than about 10% of the average maximum cross-sectional dimension of the templating elements. In some cases, no more than about 5% of the templating elements have a maximum cross-sectional dimension that varies by more than about 5%, about 3%, about 1%, about 0.3%, about 0.1%, about 0.03%, or about 0.01% of the average maximum cross-sectional dimension of the templating elements. As used herein, the “average maximum cross-sectional dimension” of a plurality of objects (e.g., templating elements) is the arithmetic average of the maximum cross-sectional dimensions of each of the objects, unless explicitly stated otherwise.

In some instances, the templating elements may be substantially different in shape and/or size (“polydisperse”). For example, the templating elements may have a distribution of maximum cross-sectional dimensions such that at least about 10% of the templating elements have a maximum cross-sectional dimension that varies by at least about 10%, at least about 20%, at least about 50%, or at least about 100% of the average maximum cross-sectional dimension of the templating elements. In some cases, at least about 20%, at least about 30%, or at least about 50% of the templating elements have a maximum cross-sectional dimension that varies by at least about 10%, at least about 20%, at least about 50%, or at least about 100% of the average maximum cross-sectional dimension of the templating elements.

Templating elements described herein may be of any suitable phase and/or composition (e.g., solid, liquid, or gaseous). As a specific example, the templating elements may comprise gas bubbles. The gas may be any suitable gas, for example, comprising air, O₂, CO₂, CO, CR₄, N₂, Ar, or the like, as well as combinations of these and/or other materials. In other cases, the templating elements may comprise liquid bubbled and/or suspended in an immiscible liquid matrix. For example, the liquid may be water, chloroform, benzene, or the like, or the liquid may be an aqueous solution (i.e., one that is miscible in water) or an organic solution (i.e., one that is not miscible in water).

Thus, in some embodiments, the templating elements comprise fluids. As used herein, the term “fluid” generally refers to a substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits at least some flow of the fluid. Non-limiting examples of fluids include liquids and gases, but may also include free-flowing solid particles (e.g., cells, vesicles, etc.), viscoelastic fluids, and the like.

In still other embodiments, the templating elements may comprise solid particles. The templating elements may comprise a variety of materials. In some cases, the templating elements may be organic, while in other cases, the templating elements may be inorganic. Examples of suitable inorganic materials which the templating elements may comprise include, for example, glass (e.g., quartz, silica (e.g., amorphous silica), etc.), ceramics, and metals (e.g., stainless steel, brass, titanium), and metal salts such as oxides, chlorides, silicates, carbonates (e.g., CO₃²⁻, HCO₃⁻, etc.), phosphates (e.g., PO₄³⁻, HPO₄²⁻, H₂PO₄⁻, etc.), nitrides, nitrates, sulfates (e.g., SO₄²⁻, HSO₄⁻, etc.), and sulfides of metals. The metals may be, for example, lithium, sodium, potassium, calcium, aluminum, a transition metal, or the like. Examples of organic templating element materials include, but are not limited to, polymers (polystyrene, polypropylene, polyethylene, polytetrafluorethylene, etc.), carbon black, and graphite, among other materials.

In some instances, the templating elements may be inert (i.e., they do not chemically react, at least on a time scale of interest) and/or insoluble with respect to the interstitial fluid (or components thereof). For example, in one set of embodiments, less than about 10 wt %, about 5 wt %, about 1 wt %, about 0.5 wt %, or about 0.1 wt % of the templating element material may react with and/or dissolve in the interstitial fluid. As a specific example, the templating elements may be formed out of calcium carbonate, while the interstitial fluid comprises a solution that is substantially non-reactive with calcium carbonate. In another example, nitrogen gas may be used to form bubbles that act as templating elements within the liquid phase of an active agent in which nitrogen is insoluble. As used herein, one phase is “insoluble” in another if less than about 10 wt %, about 5 wt %, about 1 wt %, about 0.5 wt %, or about 1 wt % of one of the phases dissolves in the other phase over the time scale of interest at 298° C. and ambient pressure (1 atm). For example, in some embodiments, less than about 10 wt % (or about 5 wt %, about 1 wt %, about 0.5 wt %, or about 1 wt %) of the templating element material may dissolve in the interstitial fluid. By using templating elements that do not react with or dissolve in the interstitial fluid (or a component therein), the order of the templating elements may be retained during the hardening of the interstitial fluid.

In other embodiments, it may be desirable to use templating elements that are soluble and/or reactive with one or more interstitial fluids. The dissolution and/or reaction of a component within the templating elements may, in some instances, trigger the hardening of the interstitial fluid. For example, the templating elements may comprise a solution or a dispersion of a cross-linking agent or a radical initiator in a solvent that is insoluble in the interstitial fluid. As the cross-linking agent diffuses from the templating element into the interstitial fluid, polymerization of a polymer precursor (e.g., a monomer, such as acrylic acid, acrylate, methacrylate, styrene, butadiene, alpha-olefin, or derivatives or mixtures thereof) within the interstitial fluid may occur, leading to the formation of a hardened matrix within the interstitial spaces. As a specific example, the interstitial fluid may comprise acrylamide while the templating elements comprise ammonium persulfate. As the ammonium persulfate diffuses into the interstitial fluid, it may initiate polymerization of the acrylamide to form polyacrylamide. The hardening reaction can be triggered by any method known in the art including, but not limited to radical polymerization chemistry, heat, or irradiation (e.g., UV irradiation). In some embodiments, the templating elements comprise essentially solid particles of the reactive component.

The templating elements may comprise, in some cases, degradable materials such that the degradation products may be removed without disturbing the hardened fluid formed within the interstitial spaces. Thus, in one set of embodiments, a fluid may be introduced into at least a portion of the interstitial spaces between the templating elements, and the fluid hardened before the templating elements are degraded or otherwise removed. For example, the elements may degrade to form gaseous products, volatile liquids, and/or degradation products with altered solubility. In some embodiments, the elements may degrade to form products that are more soluble in the interstitial fluid than the original material from which the templating elements were made. In other embodiments, the elements may degrade to form products that are less soluble in the interstitial fluid than the original material from which the templating elements were made, but more soluble in a third fluid which is immiscible with the interstitial fluid (e.g., after hardening the interstitial fluid). For example, in some embodiments the templating elements comprise calcium carbonate. Treatment of the calcium carbonate templating elements with hydrochloric acid yields a gaseous degradation product (carbon dioxide) and calcium chloride, which is water soluble, unlike calcium carbonate at most pHs (e.g., in water at a pH of 7 or higher). The dissolved calcium chloride may be washed away if the interstitial fluid is not water soluble. In alternative embodiments, the calcium chloride may dissolve in aqueous interstitial fluid. In another set of embodiments, the templating elements comprise silicon dioxide or a silicate. The silicon dioxide or silicate can be degraded using hydrofluoric acid to form either volatile silicon tetrafluoride or other degradation products with altered volatility and/or solubility. Unstable substances such as azides may also be used in some cases.

In some embodiments, the template structure may comprise templating elements having a boiling point lower than the melting point of the hardened fluid contained within the interstitial spaces (e.g., with a boiling point at ambient pressure of above about 30° C., about 70° C., above 100° C., above 150° C., or higher). As this composite of templating elements and hardened fluid is heated, the templating elements may volatilize and escape the composite, e.g., through interconnected passageways formed by the templating elements within the matrix. As a specific, non-limiting example, the template structure may contain templating elements comprising water (e.g., as a liquid and/or as ice). The templating elements may be suspended in liquid phase of the active agent. The liquid phase of the active agent may be solidified, leaving a hardened active agent phase in which templating elements comprising water are arranged. As the template is heated, the water evaporates while the solidified active agent remains. In some embodiments, the templating elements comprise water or ice, and the hardened fluid comprises a radically or UV curable monomer. The curable system may be introduced into at least a portion of the aqueous templating elements and hardened (e.g., by UV irradiation). The composite may then be heated to evaporate the water. In another set of embodiments, the templating elements comprise wax droplets and/or a hydrocarbon with a suitable boiling point and/or tendency to sublimate, while the fluid to be hardened comprises an aqueous monomer system. After hardening the monomer system by conventional polymerization techniques, the templating elements may be melted and removed.

When liquids are used as templating elements, it may be advantageous to employ liquids with suitable volatility. For example, low volatility liquids may be desired in some cases (e.g., with boiling points at ambient pressure above about 100° C., above about 150° C., above about 200° C., above about 300° C., or higher). Low volatility liquids may be useful, for example, in cases where the hardened fluid within the interstitial spaces is able to withstand high temperatures (e.g., high melting point, high decomposition temperature, etc.). In such cases, using low volatility liquids may be desirable to enable easy handling of the liquid forming the templating elements and/or to prevent unwanted evaporation. In other cases, high volatility liquids may be used (e.g., with boiling points at ambient pressure below about 100° C., below about 50° C., or lower). High volatility liquids may be useful, for instance, in cases where the hardened fluid within the interstitial spaces melts and/or decomposes at low temperatures. By using high volatility liquids, evacuation of the templating elements from the hardened fluid in the interstitial spaces may be achieved using relatively low temperatures, thus avoiding damage to the hardened fluid structure and/or the components within the hardened fluid.

In some cases, the templating elements may be stabilized within the fluid medium using surface active entities. For example, in some cases, non-ionic polymers, anionic polymers, cationic polymers, or zwitterionic polymers may be employed. Surfactants, such as, for example, non-ionic surfactants, charged surfactants (e.g., positively or negatively charged surfactants), or Pickering stabilizers, among others, may be employed in some cases. Mixtures of such surface active entities may also be used. Surface active entities may be used, for example, to prevent unwanted recombination of fluid templating elements (e.g., hydrophobic bubbles dispersed in a hydrophilic matrix, etc.), thus allowing for the hardening of the interstitial fluid prior to any breakdown of the template structure.

In some cases, the templating elements can be hydrophilic. In other embodiments, the templating elements can be hydrophobic. Generally, hydrophilic liquids are miscible with water, while hydrophobic liquids are not. Hydrophilic solids will generally form a contact angle with a water droplet of less than 90° (as measured through the water droplet), while hydrophobic solids will generally form a contact angle with a water droplet of greater than 90° (as measured through the water droplet). In some embodiments, solid templating elements can be strongly hydrophilic. In other cases, solid templating elements can be strongly hydrophobic. As used herein, “strongly hydrophobic” solids form contact angles of greater than 110° with water droplets (as measured through the droplet), and “strongly hydrophilic” solids form contact angles of less than 30° with water droplets (as measured through the droplet).

As discussed above, the template structure may contain a number of interstitial spaces, which are formed in the spaces or regions located between the templating elements forming the template structure. In one set of embodiments, the template structure is present when the fluid is introduced into the template structure. In another set of embodiments, the template structure may form upon hardening at least a portion of the interstitial fluid. The templating elements themselves within the template structure may be spaced apart from, but in close proximity to another (e.g., elements 10A and 10C in FIG. 1), and/or the templating elements may be in physical contact with another (e.g., elements 10A and 10B in FIG. 1), thereby defining the interstitial spaces contained between the templating elements. In some embodiments, at least about 80% (by number), at least about 90%, at least about, 95%, at least about 99%, or substantially all of the templating elements within a template structure may be in physical contact with or in close proximity to at least one other templating element, and in some cases, more than one other templating element. The shape and/or size of the interstitial spaces may vary, depending on factors such as the shape and/or size of the templating elements, the viscosity of the interstitial fluid, the composition of the interstitial fluid, the surface tension of the interstitial fluid, the degree to which packing of the templating elements occurs, or the like.

There may be one or more interstitial spaces that are defined between the templating elements, depending on the application and the size and shape of the templating elements. In some embodiments, the volumes of the interstitial spaces may be defined by “control lines.” As used herein, “control lines” correspond to lines spanning the shortest distances between proximate templating elements that define an interstitial space. The center points of each of the control lines may define one or more polyhedral bodies. In the case of convex templating elements (e.g., spherical, elliptical, etc.), the volume of the polyhedral body is greater than the volume of the interstitial space defined by the control lines. In the case of concave templating elements, the volume of the polyhedral body defined by the control lines is of the same order of magnitude or smaller as the volume of the interstitial space. In some embodiments, at least about 80%, at least about 90%, at least about 95%, or at least about 99% of the interstitial spaces are defined by at least four control lines, the center points of the control lines defining one or more polyhedral bodies, each of the polyhedral bodies having a volume of no more than about 500% of the geometric average of the maximum cross-sectional dimensions of the templating elements defining the interstitial space raised to the third power. In some embodiments, at least about 80%, at least about 90%, at least about 95%, or at least about 99% of the interstitial spaces are defined by at least four control lines, the center points of the control lines defining one or more polyhedral bodies, each of the polyhedral bodies having a volume of no more than about 250%, about 100%, about 50%, about 25%, about 10%, about 5%, or about 1% of the geometric average of the maximum cross-sectional dimensions of the templating elements defining the interstitial space raised to the third power. The sizes and/or spacing of the templating elements may be determined, for example, using optical microscopy, scanning electron microscopy (SEM), or the like.

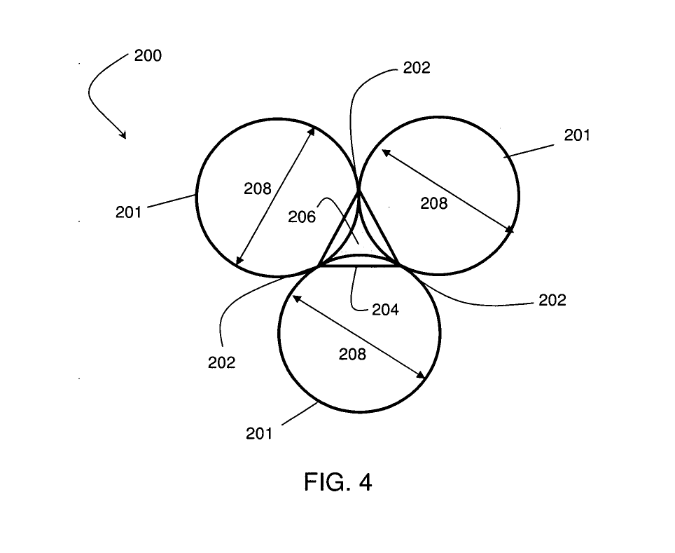

For example, FIG. 4 includes a schematic illustration of a template structure 200 in which three templating elements 201 are each in contact with two other templating elements. In FIG. 4, the control lines are the points of contact 202 between the templating elements. In FIG. 4, the volume of polyhedral body 204 is greater than the volume of interstitial space 206 defined by the control lines. In addition, the volume of polyhedral body 204 is less than about 100% of the geometric average of the maximum cross-sectional dimensions (calculated using maximum cross-sectional dimensions 208) of the templating elements 201 defining interstitial space 206 raised to the third power.

In some cases, the interstitial spaces may be interconnecting, i.e., it is possible to travel from one interstitial space to another without entering a templating element. Thus, in some cases, one or more interstitial spaces may be interconnected even when the templating elements defining the interstitial spaces are in physical contact. For example, in FIG. 1, area 20 is interconnected with neighboring interstitial space 14′ via connections that lie outside the plane of the schematic illustration. In some embodiments, at least about 50%, at least about 60%, at least about 70%, at least about 80%, at least about 90%, at least about 95%, at least about 98%, or at least about 99% of the interstitial spaces in a template structure are interconnected in some fashion.

It should be understood that, in an interconnected structure, not all of the interstitial spaces are necessarily directly connected to each other, but instead that each of the interstitial spaces within the interconnected structure are connected to at least one other interstitial space within the interconnected structure such that it is possible to travel between any two of the interstitial spaces within the interconnected structure passing through only other interstitial spaces within the interconnected structure, and without necessarily entering a templating element. In some cases, it may be possible to travel between most of the interstitial spaces within the interconnected structure passing through only other interstitial spaces within the interconnected structure. While the example template structure in FIG. 1 includes only four templating elements, this is by way of illustration only, and typical template structures will include a larger number (e.g., at least about 10, at least about 100, at least about 1000, etc. of individual templating elements). The templating elements may be arranged in any suitable configuration within the template structure. In certain instances, for example, the templating elements may be arranged according to a substantially irregular pattern. In some embodiments the templating elements may be arranged according to a substantially regular pattern. For example, the templating elements may be arranged in a triclinic, monoclinic, orthorhombic, hexagonal, rhombohedral, tetragonal, cubic, or any other suitable regular pattern. In some embodiments, however, the templating elements may be arranged substantially quasiperiodically or randomly. In some embodiments, the templating elements are packed such that the volume fraction of the templating elements relative to the volume of the entire system is equal to or greater than about 0.3, about 0.4, about 0.5, about 0.6, about 0.65, about 0.7, about 0.75, about 0.8, about 0.85, about 0.9, or greater.

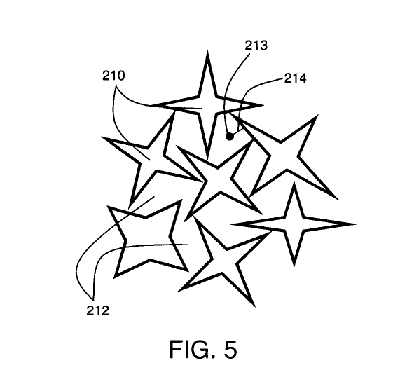

In some embodiments, the interstitial spaces may be relatively small. For example, in one set of embodiments, at least about 80% (by volume), at least about 90%, at least about 95%, at least about 98%, at least about 99%, or substantially all of the points contained within the one or more interstitial spaces are located no more than about 1000 nm, no more than about 500 nm, no more than about 250 nm, no more than about 100 nm, no more than about 50 nm, no more than about 25 nm, no more than about 10 nm, no more than about 5 nm, or no more than about 1 nm, from a templating element. For example, FIG. 5 illustrates a schematic diagram of interstitial spaces 212 formed between templating elements 210. The shortest distance between point 213 and the templating elements is indicated by line 214.

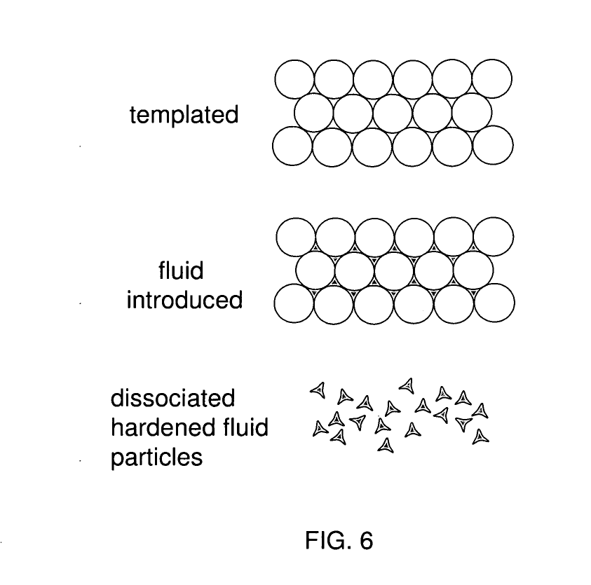

In some cases where the template structure comprises packed spherical templating elements, a large number (e.g., at least about 70%, at least about 80%, at least about 90%, at least about 95%, or more) of the interconnecting interstitial spaces have a shape similar to interconnecting tetrahedrons with concave sides. Such structures are shown, for example, in FIG. 6.

In another set of embodiments, at least about 80% (by number), at least about 90%, at least about 95%, at least about 99%, or substantially all of the interstitial spaces are defined by at least four control lines, such that each control line contains the shortest imaginary line extending between two proximate templating elements, the center points of the control lines defining one or more polyhedral bodies, each of the polyhedral bodies having a volume of no more than about (750 nm)³, no more than about (500 nm)³, no more than about (200 nm)³, no more than about (100 nm)³, no more than about (50 nm)³, no more than about (25 nm)³, no more than about (10 nm)³, no more than about (5 nm)³, no more than about (3 nm)³, no more than about 1 nm³, or less in some cases. In another set of embodiments, at least about 80%, at least about 90%, at least about 95%, at least about 99%, or substantially all of the templating elements may be closer than about 10% of its maximum cross-sectional dimension to at least one other templating element.

A fluid may be introduced into the interstitial spaces such that the fluid occupies at least a portion of the interstitial spaces. A fluid is said to occupy an interstitial space when it occupies at least a portion of the interstitial space. In some cases, a fluid occupies an interstitial space when it completely fills the space. In some embodiments, the fluid may be introduced such that the templating elements are not all covered completely with the fluid. In some embodiments, at least about 50% of the templating elements (by number), at least about 75% of the templating elements, at least about 90% of the templating elements, at least about 95% of the templating elements, at least about 99% of the templating elements, or substantially all of the templating elements are not covered completely with the fluid. Any suitable fluid may be used. In some cases, the fluid may be hardenable, i.e., the fluid can be caused to form a solid or a gel, as discussed below. Non-limiting examples of suitable interstitial fluids include polymer melts, solutions or suspensions of polymer precursors, liquid phases of an active agent (e.g., melts), solutions of active agents, mixtures of active agents and melting point depressants (e.g., urea, choline chloride, etc.), dispersions of active agents, and protein suspensions, among others. In some embodiments, the fluid can be hydrophilic. In other cases, the fluid can be hydrophobic.

The fluid may be introduced into the interstitial spaces using any suitable technique. For example, the fluid may be introduced under ambient conditions (e.g., by immersion of the template structure into the fluid or vice versa), or under high pressure in some cases. In some embodiments, the templating elements, or precursors designed to form templating elements, are dispersed within a fluid and the template structure is allowed to form within the fluid (in some cases, subsequent reactions may be necessary to convert the precursors into the templating elements). For example, in some embodiments, the template may be formed via sedimentation of templating elements within a fluid (e.g., centrifugation of a suspension of templating elements within a fluid). In some embodiments, the templating elements may comprise a water soluble compound such as urea, choline chloride, an alkali metal salt (e.g., sodium chloride, sodium sulphate, potassium chloride, etc.) and the interstitial fluid may comprise an organic material (e.g., a solution or a liquid phase of an active ingredient) that is immiscible with the water soluble compound. Formation of the template structure can then be triggered, for example, by centrifugation or a change in temperature. After hardening the interstitial fluid, the water soluble compound can be washed away, for example, with water. Colloidal crystals may be formed in the continuous fluid phase, in some cases, and subsequently rearranged to form the template structure (e.g., via “knife-blading”). Knife-blading refers to a process known to those of ordinary skill in the art in which a tool comprising a cavity of a precise depth (e.g., of 100 microns) is dragged, cavity-side down, across a colloidal dispersion on a substrate, leaving behind a regular array of colloidal particles on the substrate. In some cases, a fluid may comprise a dissolved gas such as nitrogen or carbon dioxide. Upon rapidly reducing the pressure, the nitrogen may nucleate and form bubbles within the liquid. The viscosity of the liquid may be selected such that the liquid can be hardened before the gas bubbles escape. Higher liquid viscosities may be required for systems in which hardening takes a relatively long time (e.g., long epoxy cures), while lower liquid viscosities may be appropriate for fast-hardening systems.

In some cases, the fluid may contain other species. For example, the fluid may comprise a chemically and/or biologically active agent. As used herein, “active agent” refers to a chemical compound with physiological or biological activity. Examples of active agents that may be used include drugs or pharmaceutical active ingredients, hormones, vitamins, dietary supplements, agro-chemicals, cosmetic ingredients, or the like. In some cases, the fluid may comprise a solution of active agent (e.g., an active agent or a salt thereof dissolved within a solvent). In other cases, the fluid may comprise the liquid phase of the active agent (e.g., a melt of the active agent free of solvent). Solutions and melts may be pure (i.e., containing only the active agent and/or a single solvent), or they may comprise additives (e.g., surfactants, additional solvents, etc.). The articles (e.g., hardened fluid particles, composites, and the like) may include, in one set of embodiments, one or more pharmaceutically acceptable carriers. In some embodiments, the active agent can be hydrophobic. In other cases, the active agent can be hydrophilic.

As used herein, the term “pharmaceutically acceptable carrier” means a non-toxic, inert solid, semi-solid or liquid filler, diluent, excipient, encapsulating material or formulation auxiliary of any type. Some examples of materials which can serve as pharmaceutically acceptable carriers are sugars such as lactose, glucose, and sucrose; starches such as corn starch and potato starch; cellulose and its derivatives such as sodium carboxymethyl cellulose, ethyl cellulose, and cellulose acetate; powdered tragacanth; malt; gelatin; talc; excipients such as cocoa butter and suppository waxes; oils such as peanut oil, cottonseed oil; safflower oil; sesame oil; olive oil; corn oil and soybean oil; glycols such as propylene glycol; esters such as ethyl oleate and ethyl laurate; agar; detergents such as Tween 80; buffering agents such as magnesium hydroxide and aluminum hydroxide; alginic acid; pyrogen-free water; isotonic saline; Ringer's solution; ethyl alcohol; and phosphate buffer solutions, as well as other non-toxic compatible lubricants such as sodium lauryl sulfate and magnesium stearate, as well as coloring agents, releasing agents, coating agents, sweetening, flavoring and to perfuming agents, preservatives and antioxidants. Pharmaceutically acceptable polymers such as the well known Kollidon® or Eudragit® grades can also be present.

In some embodiments, the templating elements may be aggregated to form the template structure, in some embodiments, by depletion, bridging, centrifugation, or other suitable techniques. In some instances, the templating elements may be aggregated to form a template structure by evaporating one or more solvents from the system. Templating elements may be aggregated to form a template structure, in some embodiments, by providing a suspension of templating elements over or positioned on a porous substrate, such as a gypsum substrate (e.g., via slip casting). The porous substrate may be used to remove at least a part of the solvent phase from the suspension of particles, thereby forming a template.

In some cases, the template structure may be formed by altering a property (e.g., temperature, pressure, electrolyte concentration, etc.) of a continuous fluid phase to increase its density in some locations, but not others. In other cases, the template structure may be formed by altering a property (e.g., temperature, pressure, electrolyte concentration, etc.) of a continuous fluid phase to alter the colloidal stability of dispersion particles (e.g., emulsion droplets). Methods to destabilize dispersions by temperature and/or the addition of electrolytes are known to those skilled in the art. A template structure may also be formed by adding one or more components to a continuous fluid phase. For example, the addition of salts or ionic liquids may result in the formation of discontinuous phases within the continuous fluid phase. Colloidal templating elements may be produced within the fluid phase via precipitation in some cases. The fluid phase may also be partially dried to produce templating elements.

In some embodiments, the interstitial fluid may be hardened to form a composite comprising the templating elements and the hardened fluid contained within the interstitial spaces, i.e., forming interstitial segments of the hardened fluid. The interstitial segments of hardened fluid may accordingly have the substantially same dimensions as the interstitial spaces described above. For example, in some cases, at least about 75%, at least about 80%, at least about 85%, at least about 90%, at least about 95%, at least about 99%, or substantially all of the points contained within the hardened fluid are located no more than about 1000 nm, no more than about 500 nm, no more than about 250 nm, no more than about 100 nm, no more than about 50 nm, no more than about 25 nm, no more than about 10 nm, no more than 5 nm, no more than 1 nm, or less from a templating element.

The interstitial fluid may be hardened using a variety of techniques. In some embodiments, for example, a solvent may be evaporated from the interstitial fluid to harden it and form the composite. Hardening of the fluid may also be achieved by altering the properties of the interstitial fluid, such as, for example, temperature, pressure, or electrolyte content. For example, the interstitial fluid may be cooled to harden it to form the composite (e.g., cooling a melt below its melting temperature or glass transition temperature). In other embodiments, hardening of the interstitial fluid may be achieved through a chemical reaction with the passage of time (e.g., curing an epoxy resin). Hardening may also be achieved through the addition of other compounds such as, for example, a cross-linking agent, a quenching agent, a polymerization initiator, or other compound(s). In some embodiments, a material being hardened may go through a phase change (e.g., reducing the temperature of a material below its freezing point or below its glass transition temperature). A material may also be hardened by removing a solvent from a solution, for example, by evaporation of a solvent phase, thereby leaving behind a solid phase material. In some embodiments, a material may be hardened by removing a melting point depressing agent (e.g., removing a salt or other species from a water solvent, or, for example, by removing compounds such as urea or choline chloride, e.g. by extraction, etc.). Other hardening techniques may also be used in other cases, such as those described herein.

In some embodiments, the network of templating elements may then be separated from the interstitial segments of hardened fluid. Separation of the templating elements, may comprise techniques such as depolymerization, evaporation, dissolution, chemical reaction, or other methods, depending on the type of material used. The templating elements may be separated such that the hardened phase (e.g., containing an active agent) remains substantially intact (e.g., as a dry product). For example, a composite may be formed in which the templating elements comprise calcium carbonate. Upon submersion of the composite into acid (e.g., HCl), the calcium carbonate dissolves, leaving behind a network of hardened fluid. As another example, a composite may be formed using polymeric templating elements comprising polyethylene. As the composite is heated above the combustion temperature of polyethylene, the templating elements react to form CO, CO₂, and steam. In some cases, the templating elements may comprise, for example, SiO₂ glass. The SiO₂ glass may be dissolved using HF, leaving the hardened fluid intact. In yet another example, the templating elements may comprise a positive photoresist which becomes more soluble in a developer after exposure to radiation of a suitable wavelength (e.g., UV radiation).

Once the network of templating elements is separated from the interstitial segments of hardened fluid, a porous structure may remain in certain cases, although the structure may not be porous in other cases. In some embodiments, the porous structure includes a high exposed surface area per mass of hardened fluid. For example, the porous structure has an exposed surface area per unit mass of hardened fluid of at least about 1 m²/g, about 2 m²/g, about 5 m²/g, about 10 m²/g, about 20 m²/g, about 50 m²/g, about 100 m²/g, about 200 m²/g, about 500 m²/g, about 1000 m²/g, or greater. The exposed surface area may be measured, for example, using BET analysis. BET surface area may be determined, for example, according to the standard test method ASTM-D4365.

The interstitial segments of hardened fluid may be dissociated to form a plurality of hardened fluid particles in certain embodiments of the invention. Dissociation of hardened fluid particles from the template structure may be achieved, for example, mechanically (e.g., via grinding, compacting, stretching, etc.). In some instances, the interstitial segments of hardened fluid may be chemically dissociated (e.g., by applying a chemical that dissolves and/or reacts with the relatively thin areas of the hardened fluid that connect the interstitial segments).

The hardened fluid particles may be formed in a variety of shapes and sizes, which may be determined, at least in part, by the template structure used to form the hardened fluid particles, as discussed above. For example, in some embodiments, at least about 75%, at least about 80%, at least about 85%, at least about 90%, at least about 95%, at least about 98%, or at least about 99% of the plurality of hardened fluid particles are shaped such that every point within each respective hardened fluid particle is located no more than about 1 micron, about 500 nm, about 100 nm, about 50 nm, about 25 nm, about 10 nm, about 5 nm, about 2 nm, or about 1 nm from the surface of the respective hardened fluid particle. In some embodiments, at least about 75%, at least about 85%, at least about 90%, at least about 95%, at least about 98%, at least about 99%, or substantially all of the plurality of hardened fluid particles have a maximum cross-sectional dimensions of no more than about 5 micrometers, no more than about 2 micrometers, no more than about 1 micrometer, no more than about 500 nm, no more than about 250 nm, no more than about 100 nm, no more than about 50 nm, no more than about 10 nm, no more than about 5 nm, no more than about 1 nm, or smaller.

In some embodiments, the plurality of hardened fluid particles are substantially the same shape and/or size (“monodisperse”). For example, the hardened fluid particles may have a distribution of dimensions such that no more than about 10% of the hardened fluid particles have a maximum cross-sectional dimension greater than about 10% of the average maximum cross-sectional dimension of the hardened fluid particles, and in some cases, such that no more than about 8%, about 5%, about 3%, about 1%, about 0.3%, about 0.1%, about 0.03%, or about 0.01% have a maximum cross-sectional dimension that varies by more than about 10% of the average maximum cross-sectional dimension of the hardened fluid particles. In some cases, no more than about 5% of the hardened fluid particles have a maximum cross-sectional dimension that varies by more than about 5%, about 3%, about 1%, about 0.3%, about 0.1%, about 0.03%, or about 0.01% of the average maximum cross-sectional dimension of the hardened fluid particles.

In some embodiments, a plurality of particles comprising a chemically and/or biologically active agent (e.g., particles made as described herein) are deployed into an environment in which the chemically and/or biologically active agent undergoes reaction or biological association. In some instances, the particles comprising a chemically and/or biologically active agent may be deployed as part of a product that includes other ingredients such as the templating elements, a pharmaceutically acceptable carrier, capsule filler material, etc. For example, in some embodiments, the templating material may be biocompatible (e.g., CaCO₃) and/or dissolve after administration of the formulation (e.g., under acidic conditions in the stomach or intestine).

The composites (or portions thereof) described herein may dissolve and/or disperse relatively quickly in an excess of solvent (e.g., in an excess of aqueous solvent), in some embodiments. An excess of solvent, in this context, means that the solvent is present in an amount at least sufficient to avoid the solubility limit of the solute (e.g., a hardened fluid within a composite) in the solvent. One of ordinary skill in the art would be capable of determined the amount of solvent needed to avoid the solubility limit for a given amount of solute (e.g., hardened fluid) and a given solute/solvent pair. In some cases, the hardened fluid between the templating elements can dissolve relatively quickly in an excess of solvent. In some embodiments, the entire composite may disperse (i.e., the hardened fluid may dissolve and/or disperse and the templating elements may disperse) relatively quickly in an excess of solvent.

Not wishing to be bound by any theory, the solvent in which the composite is dissolved and/or dispersed may be transported into small-scale cracks or similar features in the composite. These cracks may result, in some cases, from internal stress which arises during the formation of the composite due to, for example, differences in the coefficients of thermal expansion between the templating material and the hardened fluid. This effect may be enhanced, in some instances, when the hardened fluid is of one hydrophilicity/hydrophobicity and the templating elements are of another hydrophilicity/hydrophobicity. In some cases, the templating elements can be hydrophilic while the hardened fluid is hydrophobic. In other instances, the templating elements may be hydrophobic while the hardened fluid is hydrophilic. Not wishing to be bound by any theory, differences in hydrophobicity and hydrophilicity between the templating elements and the hardened fluid may produce repulsive forces that assist in breaking up the composite. These repulsive forces may arise, in some cases, because of interfacial tension between the solid surfaces and the invading liquid and/or because of osmotic pressure due to dissolved molecular species.

In some embodiments, the composite may be capable of substantially completely dissolving and/or dispersing in an excess of solvent (e.g., water, an aqueous solution, oil, etc.) within about 10 minutes, within about 5 minutes, within about 1 minute, within about 30 seconds, within about 10 seconds, between about 5 seconds and about 10 minutes or between about 5 seconds and about 5 minutes. In some cases, the dissolution and/or dispersion times mentioned above can be achieved without the addition of an agent designed to enhance the dissolution and/or dispersion time (e.g., an acid) to the solvent. For example, the dissolution and/or dispersion times mentioned above can be achieved in substantially pure water, in some cases. One of ordinary skill in the art would be capable of calculating dissolution and/or dispersion times, including determining when a composite (or portion thereof) has substantially completely dissolved and/or dispersed, using a UV/Vis spectrometer as described in Example 2 below and in Encyclopedia of Pharmaceutical Technology, 2nd Edition, Volume 1, edited by James Swarbrick, James C. Boylan, published by Marcel Dekker, Inc.

The dissolution and/or dispersion rate of the hardened fluid within a composite in an excess of solvent (e.g., water, an aqueous solution, oil, etc.) under ambient conditions may be, in some instances, relatively high compared to a control dissolution and/or dispersion rate of a sample of the hardened fluid having the same volume but absent the templating elements. The control dissolution and/or dispersion rate, in this context, is measured under conditions (e.g., solvent type, temperature, mixing effectiveness, etc.) that are similar or identical other than the presence of the templating elements. The hardened fluid having the same volume but absent the templating elements can comprise, for example, a plurality of crystals (e.g., crystals of active ingredient) having maximum cross-sectional dimensions of between about 1 micron to about 1 mm.

Not wishing to be bound by any theory, the dissolution and/or dispersion rate of the hardened fluid within a composite may be high, relative to the dissolution and/or dispersion rate of a sample of the hardened fluid absent the templating elements, due to the high amount of surface area of the hardened fluid within the composite that is exposed to the solvent, relative to the exposed hardened fluid surface area exposed to the solvent in the sample absent the templating elements. This effect might also arise, in some cases, due to the presence of a higher fraction of drug in the amorphous state relative to the crystalline state and/or due to the presence of smaller crystallites in the interstices. In addition, interactions between the templating elements and the hardened fluid (e.g., hydrophilic/hydrophobic interactions) may further enhance this effect.

In some embodiments, the hardened fluid (e.g., containing an active agent) in a composite can exhibit a dissolution and/or dispersion rate in an excess of solvent (e.g., an excess of aqueous solvent) under ambient conditions that is at least about 2 times, at least about 5 times, at least about 15 times, between about 2 times and about 20 times, or between about 5 times and about 20 times greater than a control dissolution and/or dispersion rate, in the same solvent, of a sample of the hardened fluid having the same volume as the composite, but absent the templating elements (e.g., a sample of substantially pure active agent).

The dissolution and/or dispersion time of the composite may be, in some embodiments, substantially independent of the size of the composite. In this context, dissolution time corresponds to the time needed to dissolve 80% of the total amount of hardened fluid present in the composite. In some embodiments, powders of various granularities might be formed from a composite, and the dissolution and/or dispersion time of the coarse powder might be similar to the dissolution and/or dispersion time of the fine powder. Such results are unexpected, as relatively small composites (e.g., relatively fine composite powders) would be expected to dissolve and/or disperse more quickly than relatively large composites (e.g., relatively coarse composite powders). Not wishing to be bound by any theory, the independence of the dissolution and/or dispersion time on composite size may be due to interactions (e.g., hydrophobic/hydrophilic interactions) between the templating elements and the hardened fluid.

In some cases, a composite is reducible to a first sub-composite having a first volume and a second sub-composite having a second volume that is at least about 10³, at least about 10⁶, at least about 10⁹, between about 10 and about 10¹², between about 10³ and about 10¹², or between about 10⁶ and about 10¹² times smaller than the first volume. The composite can be reduced to first and second sub-composites by, for example, cutting off a piece of the original composite to form two sub-composites. In some cases, the hardened fluid in the first composite having the first volume can exhibit a first non-zero dissolution and/or dispersion time in an excess of solvent (e.g., an excess of aqueous solvent), and the second composite having the second volume can exhibit a second non-zero dissolution and/or dispersion time in the excess of solvent. In some embodiments, surprisingly, the first dissolution and/or dispersion time can be within about 25%, within about 10%, within about 5%, or within about 1% of the second dissolution and/or dispersion time, relative to the smaller of the first and second dissolution and/or dispersion times, even in embodiments where the composites themselves have volumes that vary dramatically, e.g., differing by a factor of at least about 10³, at least about 10⁶, etc., as previously described above.

U.S. Provisional Patent Application Ser. No. 61/160,040, filed Mar. 13, 2009, entitled “Systems and Methods of Templating Using Particles such as Colloidal Particles,” is incorporated herein by reference.

The following examples are intended to illustrate certain embodiments of the present invention, but do not exemplify the full scope of the invention.

### Example 1

This example describes the use of templating to produce composites and discrete particles, according to one set of embodiments. Relatively poor solubility in water is a common feature of about half of potentially valuable drug candidates that are currently under development. Using the methods described herein, the dissolution rate and bioavailability of hydrophobic pharmaceutical ingredients in water may be improved. In general, the dissolution of hydrophobic drugs in water can be enhanced by delivering the drug in the form of small particles of high surface area, keeping the drug in an amorphous state, and/or changing the surface chemistry of the drug to improve wettability in water.

Two approaches were used for the preparation of template structures interstitially filled with active ingredients: (1) slip casting of suspensions to form dense arrays of silica particles, followed by introduction of the drug into the template interstices; (2) direct hot pressing of dry mixtures of drug and submicron silica particles. The silica within the drug-introduced template structures may be subsequently removed to produce drug particles with small characteristic lengths. The materials and experimental procedure used to evaluate these approaches are described below.

Silica particles with average sizes of 450, 250 and 100 nm were used for the preparation of the template structures. Particles with average size of 100 and 450 nm were acquired from Nissan Chemical Industries (grades MP 1040 and MP4540, 40 wt % solids aqueous suspension, Nissan Chemical Industries Ltd., Tokyo, Japan), whereas particles with 20 and 250 nm were obtained from Aldrich (Ludox HS-40, 40 wt % solids aqueous suspension, Sigma-Aldrich, St. Louis, Mo., USA) and from Fiber Optic Center, Inc. (grade SIOP025-01, AngstromSphere, New Bedford, Mass., USA), respectively. Hemihydrated gypsum used for the preparation of porous substrates was either acquired from Riedel-de Haan (greater than or equal to 97.0%, Riedel-de Haen/Sigma-Aldrich, St. Louis, Mo., USA) or obtained through the calcination of hydrated gypsum (Gypsum Plaster Accelerator, USG, Home Depot, Watertown, Mass., USA) at 170° C. for at least 24 hours.

Cholesterol (96%, Alfa Aesar, Ward Hill, Mass., USA) was used as a model of a relatively poorly water-soluble compound in preliminary experiments. Fenofibrate, cinnarizine and famotidine (supplied by BASF SE, Germany) were afterwards used as typical examples of relatively hydrophobic or relatively poorly water-soluble pharmaceutical ingredients. Ultrapure water with an electrical resistance higher than 18 MΩ cm was used in the experiments (Milli-Q Synthesis System, Millipore Corp., Billerica, Mass., USA). Toluene was acquired from Sigma-Aldrich (St. Louis, Mo., USA) and used as received.

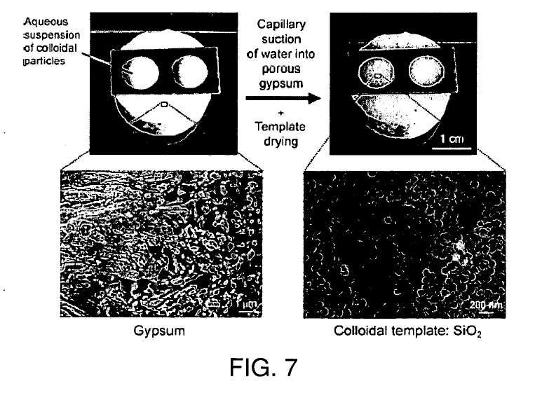

To obtain template structures, a slip casting method widely applied for the fabrication of ceramic products was used. The process uses the deposition of a fluid suspension containing dispersed or slightly agglomerated particles onto a porous substrate of specific shape. After deposition onto the porous substrate, the fluid continuous phase of the suspension was sucked into the pores of the substrate by capillary pressure, leading to the formation of a layer of densely packed particles close to the substrate wall. The process is illustrated in FIG. 7 using a gypsum porous substrate and an aqueous suspension with 40 wt % 100-nm silica particles as examples. The gypsum substrate was prepared by vigorously mixing 40 grams of hemihydrated gypsum with 23 grams of water to form an aqueous paste that could be placed into cylindrical plastic molds. Dissolution of Ca²⁺ and SO₄⁻² ions from the hemihydrated gypsum into the aqueous phase took place during the initial hours after mixing. Later, the dissolved ions precipitated into hydrated gypsum to form the hard porous material shown in FIG. 7. After hardening, the gypsum substrates were dried in an oven at 70° C. for at least one day.

Packed template structures were obtained by slip casting 40 wt % silica suspensions onto the porous gypsum substrates (FIG. 7). To avoid cracking, the silica templates were covered with a plastic cup during the first 40-60 minutes after casting and were afterwards uncovered and removed from the hard porous substrate while still in the wet state. This enabled the template to shrink laterally during drying without crack formation. After removal from the substrate, the obtained templates were fully dried in an oven at 70° C. for at least 2 hours.

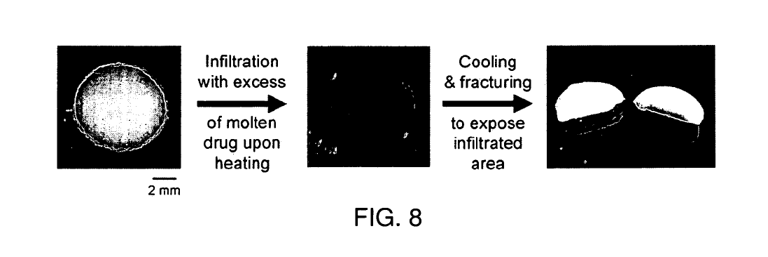

To ensure that the introduction of the hydrophobic compounds into the template structure would not lead to rearrangement of the particles in the 3D array, some of the templates were sintered prior to the introduction step. Sintering temperatures between 700 and 1200° C. were used to evaluate the conditions needed to form strong interparticle necks without distorting the initial packed structure. Sintering was accomplished under a O₂ gas flow of 0.7 L/min (Thermo Scientific Lindberg Blue M Three-Zone Tube Furnace, Cole-Parmer, Vernon Hills, Ill., USA) applying a dwell time period of 2 hours. Introduction of the hydrophobic compounds into the interstices of the packed array of particles was accomplished by first placing the template on a hot plate at a predetermined temperature and afterwards depositing the powdery hydrophobic compound on the top of the heated template. The temperature of the hot plate was adjusted to enable melting of the hydrophobic compound on the template surface. Once in liquid form, the compound was sucked into the interstices of the template structure by capillary forces. Complete introduction of fluid into the template was easily noticed by an increase in the translucency of the substrate due to the replacement of silica-air interfaces of high refractive mismatch to silica-liquid interfaces of lower mismatch (FIG. 8). After fluid introduction, the templates were removed from the hot plate and cooled in air at ambient temperature. The fluid-introduced templates were finally fractured to enable evaluation of the fluid-introduction efficiency in an electron microscope.

Hot pressing of dry mixtures containing submicron particles and hydrophobic compounds was also evaluated as a direct means to produce template structures with interstices filled with the active ingredients. This evaluation was carried out using 100-nm silica particles and fenofibrate as a model system.

To obtain a homogeneous mixture, the particles and the hydrophobic compounds were initially added to a toluene solution and deagglomerated using ultrasonication. The liquid content of the suspensions obtained was afterwards evaporated to form a dry powdery mixture of particles and the hydrophobic compound. This mixture was poured into a metallic cylindrical mold surrounded by a custom-made heating jacket (A510-HARV1008-22, HTS/Amptek Company, Stafford, Tex., USA) connected to a temperature controller (BT15-B2-K-2, HTS/Amptek Company, Stafford, Tex., USA). A hydraulic press (model #3912, Carver Laboratory Equipment, Inc., Wabash, Ind., USA) was then used to apply pressure onto the dry mixture while the temperature of the heating jacket was increased. A pre-pressure of 100 MPa was first applied for 10 seconds and afterwards released to allow for the removal of entrapped air from within the powder. When the temperature reached values slightly above the melting point of fenofibrate (79-82° C.), a constant pressure of 430 MPa was applied for 10 minutes onto the powder/drug mixture. Finally, the pressure was released and the fluid-introduced templates were cooled in air at ambient temperature.

Template structures obtained before and after the introduction of fluid were fractured to allow for observation of the fracture surface in a scanning electron microscope (Supra 55VP, Carl Zeiss NTS GmbH, Oberkochen, Germany). Before the structural analysis, samples were coated with a thin Pt/Pd layer to obtain surface conductive specimens. The metallic coating was applied by sputtering in an argon atmosphere using a current of 40 mA for 20-60 seconds. Some of the composites were etched with dilute NH₄F—HF aqueous solutions (Buffered Oxide Etch) for 5 minutes in order to remove the silica particles from the template and thus form porous structures made out of the hydrophobic compound alone. The obtained structures were also observed under the scanning electron microscope.

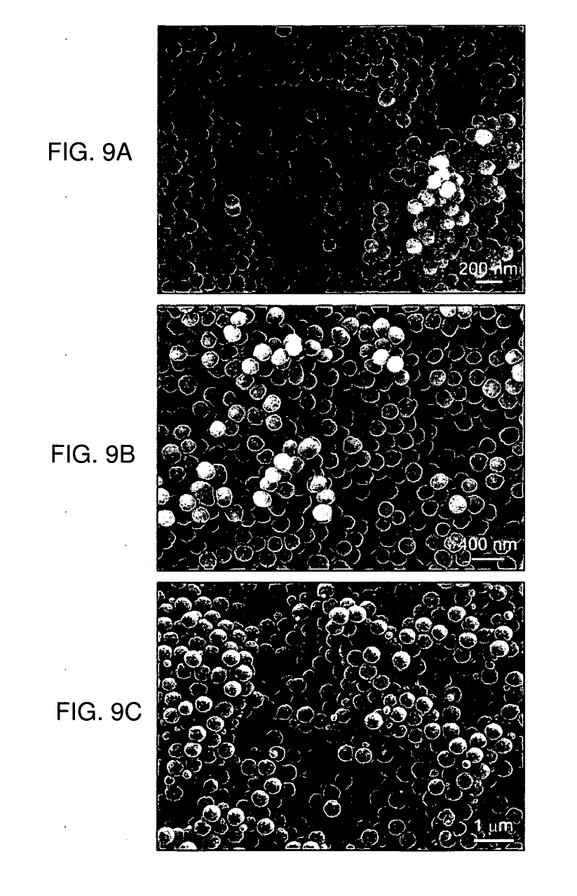

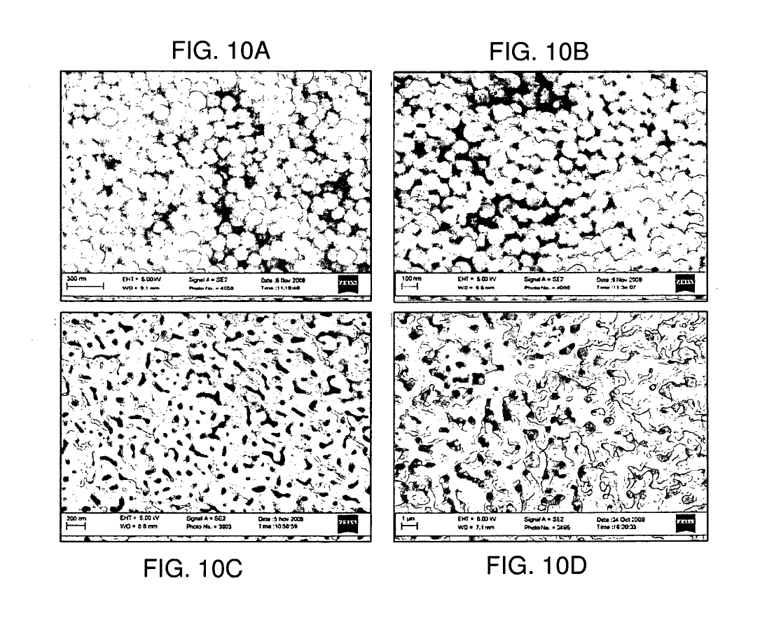

Slip casting of suspensions onto the porous gypsum substrates led to the formation of highly packed three-dimensional template structures, as shown in FIGS. 9A-9C. The interstices between packed particles could be tailored by using colloidal particles of different sizes. Image analyses of these colloidal structures showed that particles with average sizes of 100 (FIG. 9A), 250 (FIG. 9B), and 450 nm (FIG. 9C) led to the formation of templates containing interstices with sizes within the ranges 10-50 nm, 30-100 nm, 50-150 nm, respectively. Heat treatment of the templates at different temperatures changed the original colloidal structures due to the onset of sintering and densification processes, as exemplified in FIGS. 10A-10D for templates with 100 nm-sized particles treated between 700 and 1000° C. Liquid-phase sintering of the silica particles in templates treated at 900 and 1000° C. (FIGS. 10C and 10D, respectively) resulted in distortion of the original structure, with the formation of some closed pores and regions of fully dense silica. In contrast, templates heat treated at 700 and 800° C. (FIGS. 10A and 10B, respectively) exhibited substantially the same open pores of the original structure. Sintering at 800° C. (FIG. 10B) in particular led to the formation of solid necks between the particles that significantly increased the rigidity and strength of the structure without distorting the original shape and size of the interparticle interstices.

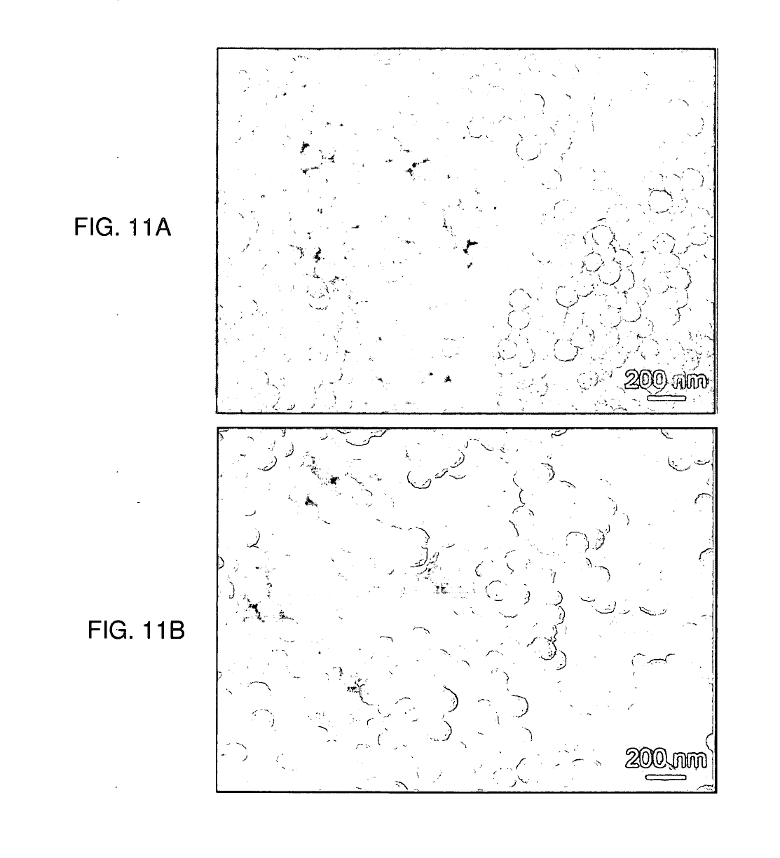

Introduction of cholesterol into the templates resulted in composite structures with densely packed silica particles and interparticle interstices filled with cholesterol (FIGS. 11A-11B). FIGS. 11A-11B include micrographs of non-sintered template structures produced by slip casting 100 nm silica suspensions (a) before and (b) after introduction of cholesterol. The template structure was not distorted during the fluid introduction process even in samples that were not previously sintered. As a result, the characteristic length scale of the cholesterol film generated around the particles remained in the desired range of 10-50 nm set by the original template.

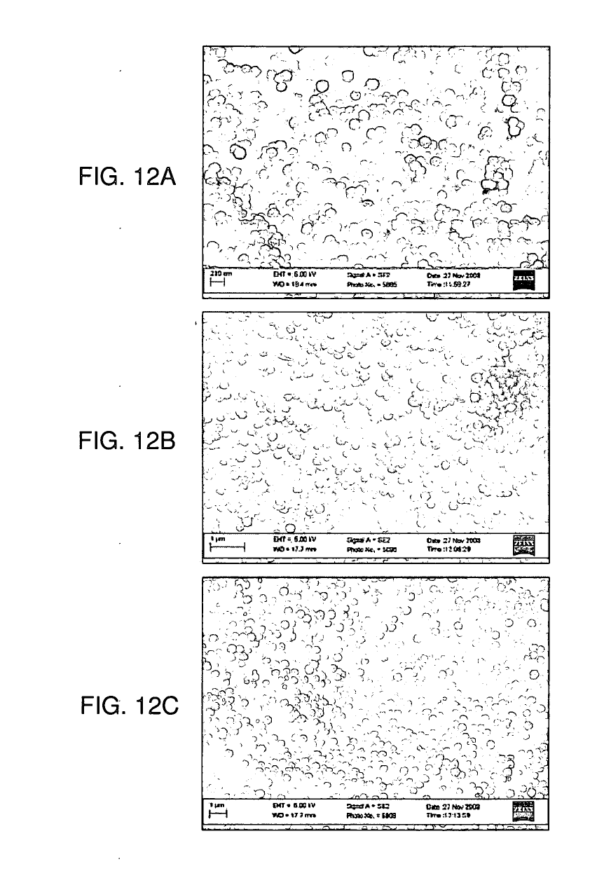

Using this approach, composites were also obtained with silica particles of different sizes interstitially filled with an interconnecting network of the pharmaceutical ingredient fenofibrate, as shown in FIGS. 12A-12C. In FIGS. 12A-12C, non-sintered colloidal templates produced by slip casting of suspensions are shown with (a) 100, (b) 250 and, (c) 450 nm particles after introduction of fenofibrate. Since the template structure was not distorted during the fluid introduction process, fenofibrate with characteristic length scales in the ranges of 10-50 nm, 30-100 nm and 50-150 nm were successfully obtained using silica particles with a diameter of 100, 250 and 450 nm, respectively. Experiments with other pharmaceutical ingredients revealed that the introduction of fluid into the templates with molten compounds can be readily applied to drugs that can be melted without decomposition such as fenofibrate and cinnarizine.

Alternatively, the introduction of high-melting-point compounds into the template structure should be feasible by first dissolving the substance into a solvent and then introducing it into the template structure and drying of the drug solution in a single step or in multiple steps.

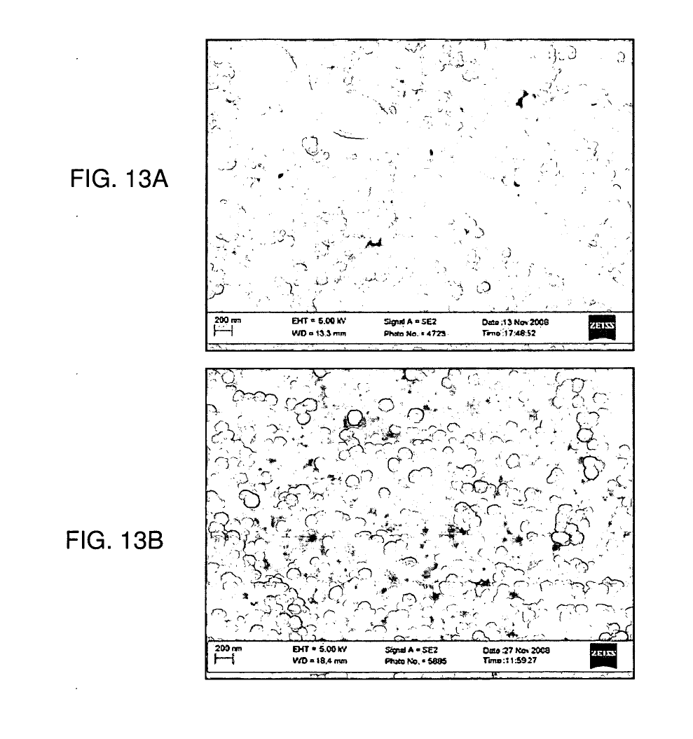

Samples containing low-melting-point drugs were susceptible to structural distortions during the sputtering procedure and during observation in the electron microscope. FIGS. 13A-13B include micrographs of colloidal templates containing 100 nm SiO₂ particles into which fenofibrate was introduced after sputtering with a Pt/Pd layer for (a) 60 and (b) 20 seconds. The templates were sintered at 800° C. for 2 hours before fluid introduction and sputtering. The high electric field generated during sputtering and the high-voltage electron beam used during electron microscopy led to local melting and to the formation of large domains of the drug on the top of the template surface in some cases (FIG. 13A). This effect was also observed in some instances in which templates were strongly sintered, and thus was not related to particle rearrangement within the colloidal structure during fluid introduction. To avoid this artifact, a minimum sputtering time of 20 seconds was used during sample preparation, and the electron microscopic analyses were accomplished using relatively low voltages and minimum exposure of the samples to the electron beam.

Pressing of drug/particle mixtures at temperatures slightly above the drug melting point enabled the direct preparation of composite structures containing drug within the interstices of densely packed colloidal particles. Particle-drug composite structures were obtained by hot pressing fenofibrate:SiO₂ mixtures at a mass ratio of 1:2, which corresponds to a volume fraction of 0.48. It should be understood, however, that these ratios are by way of example only, and other packing ratios (including much higher volume fractions) can also be obtained, using techniques similar to those described above. A homogenous structure was obtained for this mass ratio. Particle-drug composite structures were also obtained by hot pressing fenofibrate:SiO₂ mixtures at a mass ratio of 1:1, which corresponds to a volume fraction of 0.31. The composite obtained at this mass ratio exhibited a highly heterogeneous structure of particle-rich and particle-free phases. Taking into account a random close packing fraction of 0.63, excess of drug was present in both compositions evaluated. A densely packed array of particles was obtained even in the presence of an excess of drug in the mixture. Not wishing to be bound by any theory, this may have been a result of attractive van der Waals forces between the particles, which ultimately led to the formation of a dense network of agglomerated particles throughout the drug continuous phase. The small interstices formed within the agglomerates may have sucked the molten drug by capillary forces into the densely packed array of particles, resulting in the formation of a drug-introduced colloidal structure similar to that obtained using the two-step casting/introduction procedure described earlier. The observation that particles self-assemble into densely packed arrays even in the excess of drug suggests that the formation of dense template structures before fluid introduction may not necessarily be a prerequisite for the formation of small interstices between particles.

Mixtures containing a lower particle concentration (drug:particle mass ratio of 1:1) showed a heterogeneous structure consisting of particle-rich and particle-free phases. Considering that such heterogeneous structures contained domains of drug that were a few micrometers in size, lower bioavailability was expected from such drug particle composites. In contrast, mixtures containing a high amount of particles relative to drug (drug:particle mass ratio of 1:2) exhibited a homogenous distribution of drug and particles throughout the entire composite structure. Since the drug exhibited a characteristic length scale smaller than 100 nm and micron-sized drug domains were absent, the bioavailability of the active ingredient in these composites should be significantly higher than that of regular micron-sized drug particles.

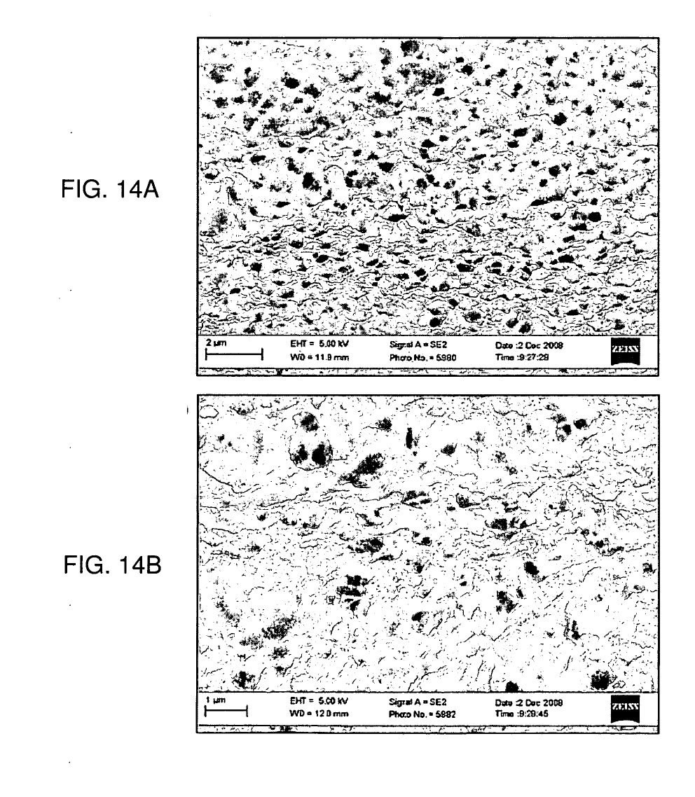

The silica particles can be removed by chemically etching the particles with hydrofluoric acid solutions. Removal of the colloidal particles by chemical etching led to the formation of a foam structure consisting of submicron open pores whose 30-100 nm thick lamellae were made out of the hydrophobic compound. This is illustrated in FIGS. 14A-14B for the case of cholesterol as a model hydrophobic compound. Etching with a hydrofluoric acid solution did not seem to distort the inner porous structure of the foam, leading to a material with remarkable specific surface area. It is believed that the coarse features on the sample surface were caused by the partial melting of the cholesterol during sputtering and exposure to the electron beam. The preparation of foams with nano-sized structural elements made of drug was expected to considerably increase the bioavailability of relatively poorly water soluble pharmaceutical ingredients.

### Example 2

Dissolution tests were performed using a home-built dissolution setup designed to follow U.S. Pharmacopeia standards. These results indicated that a variety of drug-template composites (silica, d=100 nm and d=360 nm; CaCO₃, d=70 nm) exhibited increased dissolution rates, relative to the pure, unprocessed crystalline drug (micron sized crystals). Leaching of the template before dissolution was not necessary to achieve a significant improvement in dissolution rate relative to the dissolution rate of the raw, unprocessed, crystalline drug. Instead, the dense drug-template composite exhibited rapid breakup and dissolution in aqueous dissolution media.

Sample preparation. Samples of pure, unprocessed drug were prepared in the following manner. Crystalline drug powders were provided in bulk quantities by BASF (99 wt % pure). Optical microscopy indicated that the drug powders were in the form of large crystals with a distribution of sizes (about 1 micron to about 100 microns). The sample powders were prepared for dissolution by mild grinding of the sample with a hand-held mortar and pestle. No significant change in the crystal size distribution was observed upon grinding. The powders were not combined with any excipients or encapsulated, and were added to the dissolution media in powder form.

Drug-template composites were prepared in the following manner. Templates were prepared from an aqueous colloidal dispersion using the slip-casting method described previously. After slip-casting, the templates were dried in an oven at 110° C. for 12 hours. The templates were then placed on a hotplate at a temperature approximately 5° C. to 10° C. above the melting point of the drug. A small amount of the raw crystalline drug was placed on the surface of the hot template. As the drug was melted, it was drawn into the template by capillary action. These steps were repeated until the template was filled completely. Full infiltration of the drug was verified visually (the template became transparent as the liquid drug propagated into the template) as well as by mass measurements. The drug-template composites were prepared for dissolution by mild grinding of the sample with a hand-held mortar and pestle. After grinding, optical microscopy indicated that the composite powders had an approximate size distribution from 1 microns to 0.5 mm.

Dissolution setup and protocol. The rate of drug dissolution into aqueous media was measured. Sample powders were dispersed in 300 mL of dissolution media and stirred at a rate of 50 revolutions/minute. Dissolution media was drawn through silicone tubing from the bottom of the main reservoir through a 0.45-micron PTFE (Teflon) filter, into a quartz flow-through cell (0.1 or 1 cm pathlength) mounted in a UV-Vis spectrophotometer, then back into the top of the main reservoir, forming a closed loop. The flow was driven by a peristaltic pump at a rate of 15 mL/min. UV absorbance was measured at a wavelength specific to each drug. Dissolution tests were performed under “sink” conditions; that is, the amount of drug added to the dissolution media was a third of the saturation concentration in the dissolution media. A flow-through cell with the appropriate path length (0.1 cm or 1 cm) was chosen in order keep the absorbance, A, below 1. Pure dissolution media was used as a solvent blank. The starting time (t=0) corresponded to the time at which the sample powder (pure or composite) was added to the stirred dissolution media. Dissolution profiles were measured for approximately 30 to 120 minutes.

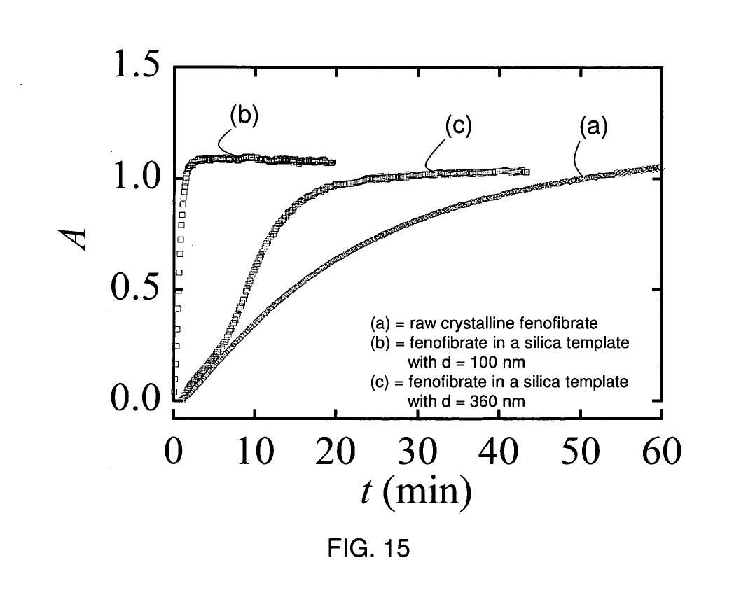

A dissolution medium with a pH of 1.5 was prepared by the addition of hydrochloric acid to distilled water. Sodium dodecyl sulfate (SDS) was added at a concentration of C_{SDS}=10 mM in order increase the solubility of the drugs in the dissolution media. As a demonstration of dissolution from a non-leachable template, a plot comparing the dissolution of pure, crystalline fenofibrate and fenofibrate drawn into the interstitial space of two different silica templates (d=100 nm and d=360 nm) is shown in FIG. 15. Fenofibrate was used in this example as a model drug. In FIG. 15, the absorbance, A, (which represented the amount of dissolved fenofibrate) was measured at a wavelength of 290 nm and plotted as a function of time. All samples contained 10+/−0.5 mg of fenofibrate and A˜1.1 represented full dissolution of the drug. The template did not need to be leached away in order to expose a large amount of drug surface area before dissolution. This effect was not sensitive to particle size of the ground composite; even powders with mm-sized chunks dissolved rapidly.

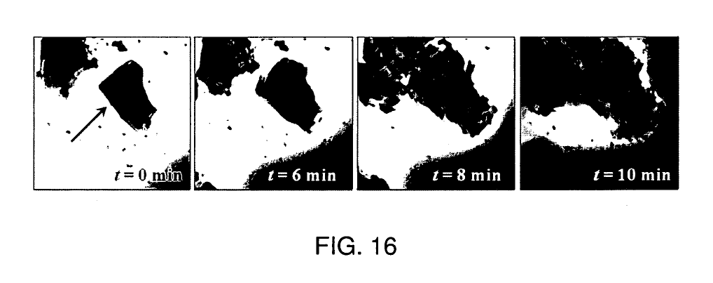

A series of confocal microscopy images in FIG. 16 depict the rapid breakup of a fenofibrate-silica (d=100 nm) composite. After grinding in a mortar and pestle, the composite powder was dispersed in dissolution media (pH=1.5, C_{SDS}=10 mM) containing an aqueous fluorescent dye (Rhodamine 6G, bright region) and a droplet of the suspension was immediately placed in a sealed microscope cell and imaged. The composite (indicated by the arrow) lost its mechanical integrity in less than 10 minutes. A small amount of advection, likely driven by partial evaporation of the media and observed by the suspension front, moved into view from the bottom right and leads to breakup of the fragile composite.

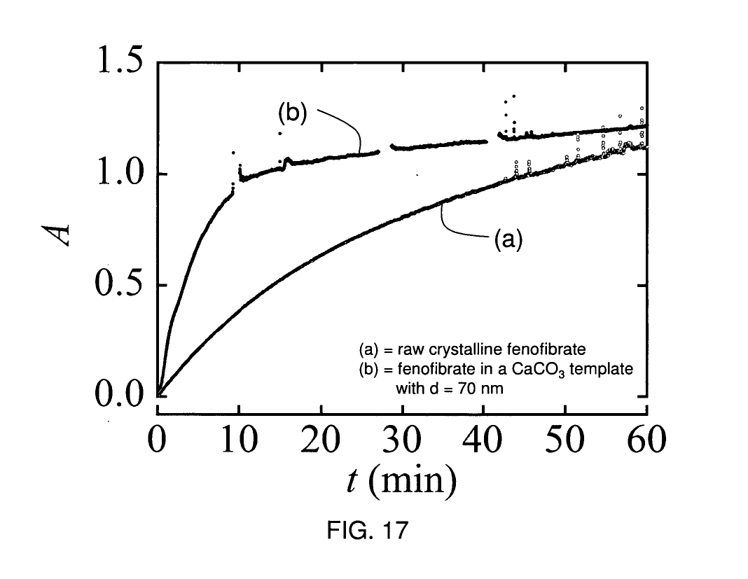

As a demonstration of dissolution from a leachable template, a plot illustrating the dissolution of pure, crystalline fenofibrate and fenofibrate imbibed into the interstitial space of a CaCO₃ template (d=70 nm) in aqueous media (pH=1.5, C_{SDS}=10 mM) is shown in FIG. 17. For this set of experiments, absorbance, A, was measured at a wavelength of 290 nm. Both samples contained 10+/−0.5 mg of fenofibrate and A≈1.1 represented full dissolution of the drug. The drug composite exhibited a significantly faster dissolution rate than the unprocessed drug.

The techniques described above for fenofibrate (melting point, Tₘ=80) have been extended to additional, higher-melting point pharmaceutical actives, including cinnarizine (Tₘ=120° C.), chlotrimazole (Tₘ=148° C.), ketoconazole (Tₘ=150° C.), itraconazole (Tₘ=166° C.), and estradiol (Tₘ=179° C.). All of these actives were stable upon melting under atmospheric conditions and infiltrated both the SiO₂ and CaCO₃ templates fully. Although cinnarizine, chlotrimazole, ketoconazole, itraconazole, and estradiol were expected to be thermally stable against degradation under atmospheric conditions at temperatures just above (e.g., <10° C.) their melting points, and although they exhibited no visible color change upon melting and infiltration into the composites, proton NMR was performed for each to further verify the lack of degradation. The samples were prepared for NMR by the following procedure. Unprocessed, crystalline powders (BASF) were dissolved in deuterated solvents at a concentration of approximately 10 mg/mL and filtered through a 0.2 micrometer PTFE filter to remove any solid impurities before running NMR measurements. Drug-silica composites were ground using a hand-held mortar and pestle, dissolved in deuterated solvents at a (drug) concentration of approximately 10 mg/mL and filtered through a 0.2 micrometer PTFE filter to remove the silica template and any additional solid impurities before running NMR measurements. Fenofibrate, ketoconazole, chlotrimazole and cinnarizine were dissolved in deuterated chloroform. Estradiol was dissolved in deuterated DMSO. Proton NMR spectra for all of five drugs before and after melting and infiltration did not show any signs of degradation (data not shown). While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
providing a template structure comprising a plurality of templating elements defining one or more interconnecting interstitial spaces, wherein at least about 80% of the points contained within the one or more interstitial spaces are located no more than about 1000 nm from a templating element, and wherein the volume fraction of the templating elements in the template structure is at least about 0.5;
introducing a fluid into at least a portion of the interstitial spaces; and
hardening the fluid to form a composite comprising the templating elements and interstitial segments of hardened fluid.

2-6. (canceled)

7. A method as in claim 1, wherein the plurality of templating elements comprises a solid.

8. A method as in claim 1, wherein the plurality of templating elements comprises a fluid.

9-10. (canceled)

11. A method as in claim 1, wherein the fluid in at least a portion of the interstitial spaces comprises a polymer precursor.

12-17. (canceled)

18. A method as in claim 1, wherein providing a template structure comprises providing a suspension of templating elements, the suspension positioned on a porous substrate.

19-26. (canceled)

27. A method as in claim 1, further comprising increasing the temperature of the composite while applying pressure.

28-36. (canceled)

37. A method as in claim 1, wherein hardening the fluid comprises polymerizing the fluid.

38. A method as in claim 1, wherein hardening the fluid comprises solidifying the fluid.

39. A method as in claim 1, wherein hardening the fluid comprises forming a gel.

40-42. (canceled)

43. A method as in claim 1, wherein at least about 50%, by number, of the templating elements are not covered completely with the fluid.

44-57. (canceled)

58. A method as in claim 1, further comprising separating the network of templating elements from the interstitial segments of hardened fluid.

59. A method as in claim 1, further comprising dissociating the interstitial segments of hardened fluid to form a plurality of hardened fluid particles.

60-61. (canceled)

62. A method as in claim 1, further comprising removing the templating elements from the composite.

63-66. (canceled)

67. A method as in claim 1, wherein hardening comprises cooling the fluid to form the composite.

68. A method as in claim 1, wherein hardening comprises evaporating a solvent from the fluid to form the composite.

69-70. (canceled)

71. An article, comprising:
a template structure comprising a plurality of templating elements defining one or more interconnecting interstitial spaces, and
a hardened fluid within at least a portion of the interstitial spaces,
wherein the volume fraction of the templating elements in the template structure is at least about 0.5, and
wherein the hardened fluid is capable of substantially completely dissolving within an excess of aqueous solvent within about 10 minutes.

72-73. (canceled)

74. An article, comprising:
a template structure comprising a plurality of substantially spherical templating elements having a maximum cross-sectional dimension of less than about 1 mm, defining one or more interconnecting interstitial spaces, and
a hardened fluid within at least a portion of the interstitial spaces,
wherein the volume fraction of the templating elements in the template structure is at least about 0.5.

75-77. (canceled)

78. An article as in claim 71, wherein the hardened fluid exhibits a dissolution rate in the excess of aqueous solvent under ambient conditions that is at least about 2 times greater than a control dissolution rate, in the excess of aqueous solvent, of a sample of the hardened fluid having the same volume but absent the templating elements.

79. An article as in claim 71, the article being reducible to form a first sub-composite with a first volume and a second sub-composite with a second volume that is at least 10³ times smaller than the first volume, wherein the hardened fluid within the first sub-composite exhibits a first non-zero dissolution time in the excess of aqueous solvent and the hardened fluid within the second sub-composite exhibits a second non-zero dissolution time in the excess of aqueous solvent, the first dissolution time being within about 25% of the second dissolution time, relative to the smaller of the first and second dissolution times.

80. An article as in claim 71, wherein the templating elements have an average maximum cross-sectional dimension of less than about 10 microns.

81. An article as in claim 71, wherein at least about 80% of the points contained within the interstitial spaces are located no more than about 500 nm from a templating element.

82-83. (canceled)

84. An article as in claim 71, wherein at least some of the templating elements are spherical.

85-86. (canceled)

87. An article as in claim 71, wherein the templating elements within the template structure have a volume fraction of at least about 0.7.

88. An article as in claim 71, wherein the mass ratio of the templating elements to the hardened fluid is at least about 1.5:1.

89-92. (canceled)

93. An article as in claim 71, wherein at least about 50%, by number, of the templating elements are not covered completely with the fluid.

94-98. (canceled)

99. An article as in claim 71, wherein the shortest distance between the two surfaces of the two elements is less than or equal to about 10% of the geometric average of the maximum cross-sectional dimensions of the two elements.

100. An article as in claim 71, wherein at least about 80% of the templating elements are proximate to at least one other templating element such that the distance between the two surfaces of the two templating elements less than or equal to about 5% of the geometric average of the maximum cross-sectional dimensions of the two templating elements.

101-105. (canceled)
